(19) United States
(12) Patent Application Publication
(10) Pub. No.: US 2010/0159360 A1
(43) Pub. Date: Jun. 24, 2010

(54) Arangement and method for providing a fuel cell with an oxidizing agent

(76) Inventors: Manfred Stute, Esslingen (DE); Siegfried Sumser, Stuttgart (DE)

Correspondence Address: KLAUS J. BACH, 4407 TWIN OAKS DRIVE, MURRYSVILLE, PA, 15668, US

(21) Appl. No.: 12/653,731

(22) Filed: Dec. 17, 2009

Related U.S. Application Data
(63) Continuation-in-part of application No. PCT/EP2008/004344, filed on May 31, 2008.

(30) Foreign Application Priority Data
Jun. 20, 2007 (DE) 10 2007 028 297.6

(51) Int. Cl. H01M 8/02

(52) U.S. Cl. 429/513

(57) ABSTRACT

In a device and method for providing a fuel cell with an oxidizing agent via a supply line which leads to a cathode chamber of the fuel cell and in which a compressor is arranged, and a discharge line which extends from the cathode chamber to an expander and wherein a bypass line extends between an output of the compressor and an inlet to the expander while bypassing the fuel cell with a first flow control valve arranged in the bypass line, a recirculation arrangement is provided for returning oxidizing agent from the supply line downstream of the compressor to the supply line upstream of the compressor.

This is a Continuous-In-Part Application of pending international patent application PCT/EP2008/004344 filed May 31, 2008 and claiming the priority of German patent application 10 2007 028 397.6 filed Jun. 20, 2007.

### BACKGROUND OF THE INVENTION

The invention relates to an arrangement for providing a fuel cell with an oxidizing agent, including a compressor with a supply line leading to the fuel cell cathode chamber, and a discharge line leading from the cathode chamber to an expander with a bypass line which extends between an output of the compressor and an input of the expander for bypassing the fuel cell, and in which a first flow control element is arranged and also to a method for providing a fuel cell with an oxidizing agent.

Such a device and such a method are known, in principle, from DE 102 16 953 A1 demands to a fuel cell are established mainly by the dosing of the supply of the oxidizing agent and of the fuel to the fuel cell. The oxidizing agent or air is supplied to the fuel cell with the necessary operating pressure in an installation space-saving manner via radial compressors rotating at high speeds. The air supply to the fuel cell is controlled by controlling the speed of the radial compressor(s) based on the maximum flow capacity of the system downstream of the compressed air. The maximum operating flow of the system and thus the air flow rate is generally determined by a controllable counter-pressure flap which is arranged downstream of the fuel cell, and represents the smallest flow cross section of the system.

DE 102 16 953 A1 discloses a variable turbine which is provided in place of the counter-pressure flap with the advantage that a considerable part of the otherwise lost throttle energy can be recovered via the turbine. With the turbine recuperating part of the energy, the power demand on the electric motor for driving the compressor is reduced by up to 30% at the nominal operating point. A motor vehicle with such a fuel cell system including an expansion turbine for the air supply unit offers a consumption advantage compared to a fuel cell with a counter-pressure flap of about 5% or more. Furthermore, the costs for the fuel cell stack can thereby be reduced by about 5 to 10%.

Since the air supply line downstream of the compressor is in communication with the exhaust line of the fuel cell upstream of a variable turbine only via the intermediate pressure differential, a noticeably more sensible and higher influence on the operating behavior of the drive unit by the variable turbine in cooperation with the electric motor in the air supply unit of the fuel cell system can be established.

It is the principal object of the present invention to provide a fuel cell system with an improved operating behavior of the fuel cell by an improved control capability of the oxidizing agent supply to the fuel cell.

### SUMMARY OF THE INVENTION

In a device and method for providing a fuel cell with an oxidizing agent via a supply line which leads to a cathode chamber of the fuel cell and in which a compressor is arranged, and a discharge line which extends from the cathode chamber to an expander and wherein a bypass line extends between an output of the compressor and an inlet to the expander while bypassing the fuel cell with a first flow control valve arranged in the bypass line, a recirculation arrangement is provided for returning oxidizing agent from the supply line downstream of the compressor to the supply line upstream of the compressor.

This arrangement permits an improved control of the oxidation agent supply by recirculation of the oxidizing agent, and the dosing of the oxidizing agent and of the cathode gas flow depending on the situation in a predetermined manner thereby providing for an improved operation of the fuel cell, with an improved energy balance of the fuel cell system.

The energy recovery in the fuel cell system can thereby also be improved.

The arrangement permits an adjustment of the performance curve for optimal operating efficiency of the fuel cell. The performance curve of the fuel cell can thus be optimized by the oxidizing agent supply system.

The expander is preferably a turbine with a variable turbine guide vane structure. In addition to the overall advantages with regard to the fuel consumption of the drive unit, such an expansion turbine offers great advantages with regard to the air flow volume control in connection with specific operating states of the fuel cell system. In particular, the operating states of load control, the cold start with the subsequent heating phase or warm-up phase, the idling operation or a completely load-free operation of the device are to be mentioned. With the device according to the invention provided with an expander in the form of a variable turbine, distinctive operating modes as mentioned above can be achieved in an energy-efficient and optimized manner.

A flow control valve arranged in the recirculation line for re-circulating oxidizing agent is preferably opened at least intermittently in a heating phase of the fuel cell and/or at least intermittently in an idling operating phase of the fuel cell.

Additionally a second flow control valve arranged in the bypass line may be opened at least intermittently in a heating phase of the fuel cell and/or at least intermittently in an idling operating phase of the fuel cell. The specified oxidizing agent supply to the fuel cell can thus be adjusted depending on need and operating conditions, so that an optimized operating behavior of the system can be achieved.

In the heating phase and the idling operating phase of the fuel cell, an operating state of a compressor is preferably established, which is characterized by a low efficiency of the compressor and its operation close to the surge limit. In this way, the necessary operating temperature of the fuel cell can be quickly established in the warm-up phase. The energy input for the temperature increase by means of the bypass operation to the expander of the air supply device however requires a corresponding electric power supply to the electric motor for driving the compressor and the expander.

In the idling phase of the fuel cell, an opening may be provided in the recirculation device for returning oxidizing agent and/or the bypass line, wherein the recirculation line the bypass line to the expander is considered to be the energetically more advantageous manner with regard to the fuel consumption compared to the opening of the recirculation device.

With a load disconnection or loss of the fuel cell or in a phase in which the fuel cell requires no or only a small amount of oxidizing agent, the expander or turbine is preferably shut down completely. The overall operating behavior can be optimized thereby, and the energy management can be improved.

During a load loss of the fuel cell or in a phase in which the fuel cell requires no or only a small amount of oxidizing agent, the compressor is operated preferably a compressor pumping operating state. If a certain operating pressure of the fuel cell is still to be made available, this can be achieved in that the compressor is operated for a certain time in an unstable region with moderate pump pressure fluctuations without risk of being damaged. Although this is an undesired operating state of the compressor, the compressor pumping caused thereby can be used advantageously.

In the pumping operating state of the compressor, the oxidizing agent volumes present upstream and downstream of the compressor are preferably adjusted so as to provide for a controllable compressor pump behavior. This volume adjustment can especially be achieved by a recirculation arrangement for returning the cathode gas discharged from the cathode chamber back into the cathode chamber. By the tuning of damping volumes arranged upstream and downstream of the compressor, a relatively good behavior of the compressor in the unstable lower speed region can be achieved. An operation of the arrangement with a small mass flow rate through at the necessary pressure is thereby possible. Furthermore, the oxidizing agent column in the fuel cell stack can also be brought to oscillation, and oxidizing agent can be used as demanded by a fuel cell.

For the operating states of the heating phase and/or the idling operating phase and/or during load loss and/or the phase in which the fuel cell requires no or only a small amount of oxidizing agent, the specific speeds of the compressor and the specific cross section adjustment of the flow cross section of the expander adapted for efficiency improvement are depicted in a performance graph, which is deposited in a control unit. The optimum parameter values can be determined and accurately established in the performance graph. By depositing this performance graph in a corresponding control unit, the performance graph data for the specific operating states can always be accessed and the operating adjustments necessary with regard to the efficiency optimization and thus also energy-efficient operation of the components involved can be accurately established.

With a method for providing a fuel cell with an oxidizing agent according to the invention, the bypass line and/or a recirculation line for returning oxidizing agent, which branches off downstream a compressor from the supply line and is returned to the supply line upstream of the compressor, are opened at least intermittently in specific operating states of the fuel cell. The fuel cell is thereby connected to a supply line extending from the compressor to the cathode chamber of the fuel cell. Furthermore, the cathode chamber is connected to a discharge line extending from the fuel cell to an expander. The bypass line extends between the output of the compressor and the input of the expander and includes the first flow control valve. An operating optimization in specific operating states can be achieved by the method according to the invention, and the energy management of the system can also be improved.

The bypass line and/or the oxidizing agent recirculation line are preferably opened in the heating phase of the fuel cell and/or in the idling operating phase of the fuel cell. The bypass line and/or the oxidizing agent recirculation line may also be opened during a load loss of the fuel cell or during a phase in which the fuel cell requires no or only a small amount of oxidizing agent.

In the specific operating states of the fuel cell, the speed of the compressor and the flow cross-sections of the expander assigned are adjusted for efficiency improvement of the fuel cell to a characteristic performance zone provided in the control unit for achieving the desired operation of the fuel cell.

The compressor is preferably operated with a low efficiency and close to its surge limit in the heating phase and/or the idling operating phase of the fuel cell.

During load loss of the fuel cell and/or in a phase in which the fuel cell requires no or only a small amount of oxidizing agent, the flow cross section of the expander is preferably completely or almost completely closed.

The invention will become more readily apparent from the description of the following schematic drawings:

### BRIEF DESCRIPTION OF THE DRAWINGS

FIG. 1 shows schematically a arrangement according to the invention; and

FIG. 2 shows a characteristic performance graph of a compressor of the arrangement according to the invention.

### DESCRIPTION OF A PARTICULAR EMBODIMENT OF THE INVENTION

In the figures, the same elements or elements with the same function are provided with the same reference numerals.

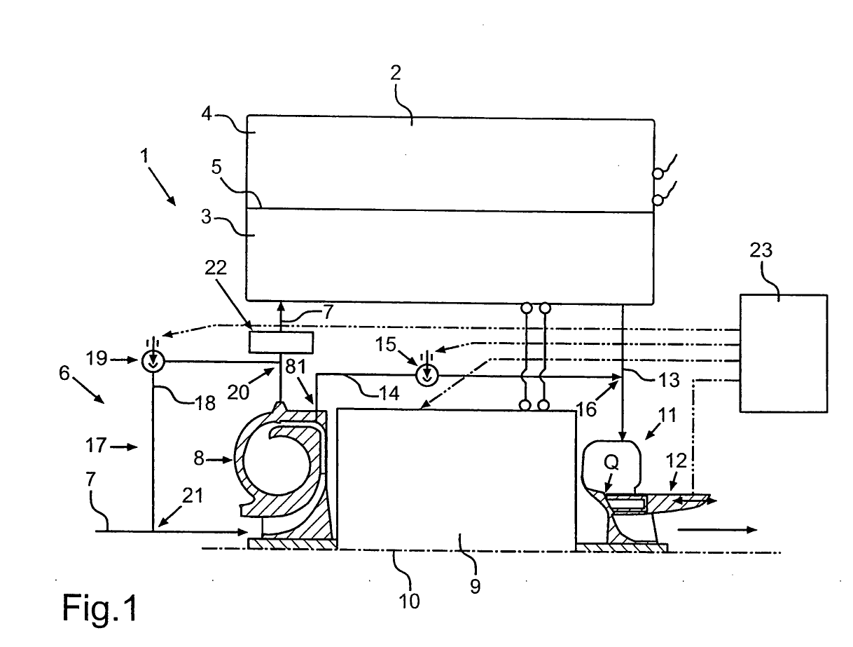

FIG. 1 shows a fuel cell system 1 which includes a fuel cell 2. Usually, several fuel cells 2 are provided, which form a fuel cell stack. The fuel cell 2 is formed as a PEM fuel cell in the particular embodiment described herein. However, this should not be seen as limiting with regard to the invention.

The fuel cell system 1 is for example in the form of a mobile fuel cell system which is installed in a motor vehicle.

The fuel cell 2 comprises a cathode chamber 3 and an anode chamber 4, which is separated from the cathode chamber 3 by a membrane 5. The fuel cell system 1 further comprises a device 6 for providing the fuel cell 2 with an oxidizing agent, for example oxygen or air. The device 6 comprises a supply line 7, in which a compressor 8 is arranged. The oxidizing agent is supplied to the fuel cell 2 via the supply line 7.

The compressor 8 is connected to an electric motor 9 via a shaft 10, by way of which the compressor 8 is driven. An expander 11 in the form of a turbine is also arranged on the common shaft 10. The turbine 11 has a variable turbine guide vane structure 12 for controlling operation of the turbine 11 which is also connected to the electric motor 9 via the shaft 10.

The cross section Q of the flow channel in the turbine 11 can be changed in a variable manner by the guide vane structure 12.

A discharge line 13 extends from the fuel cell 2 to the turbine 11 for conducting cathode gas discharged from the cathode chamber 3 away.

The device 6 further comprises a bypass line 14, which extends between an output 81 of the compressor 8 and an input of the turbine 11. In the embodiment shown, the bypass line 14 opens into the discharge line 13 at the junction 16 upstream of the turbine 11. A valve 15 serving as a flow control element is arranged in the bypass line 14. The fuel cell 2 can be bypassed by an oxidizing agent via the bypass line 14.

The device 6 further comprises a recirculation arrangement 17 for returning oxidizing agent from the output of the compressor 8 back into its input. The recirculation arrangement 17 comprises a recirculation line 18, which branches off from the supply line 7 at a branching point 20 downstream of the compressor 8 and which extends to the supply line at a junction 21 upstream of the compressor 8. A flow control valve 19 is arranged in the recirculation line 18, which is in the form of a recirculation valve.

Also, a charge-air cooler 22 is arranged in the supply line 7 between the branching 20 and the input of the cathode chamber 3.

The fuel cell system 1 further comprises a control unit 23, by means of which the valves 15 and 19, the electric motor 9 and the guide vane structure 12 of the turbine 11 can be controlled.

The valves 15 and/or 19 are opened at least intermittently in a heating phase of the fuel cell 2 after a cold start and/or an idling operating phase of the fuel cell 2.

In the heating phase and during idling operation of the fuel cell 2, the compressor 8 is in an operating state, which is characterized by a low efficiency of the compressor 8 close to its surge limit. With a load loss of the fuel cell 2 or in a phase in which the fuel cell 2 requires no or only a small amount of oxidizing agent, the guide vane structure 12 of the turbine 11 in its cross section Q is closed completely or almost completely. The guide vane 12 is adjusted to a corresponding position.

During a load loss of the fuel cell 2 or in a phase in which the fuel cell 2 requires no or only a small amount of oxidizing agent, the compressor 8 can be operated in a state of compressor pumping. In this operating state of compressor pumping, the oxidizing agent flow volumes present upstream and downstream of the compressor 8 are adjusted to a controllable compressor pump behavior. This is achieved in the embodiment in that a return device is provided, not shown, with which the cathode gas discharged from the cathode chamber 3 can be returned again to the cathode chamber inlet.

In the control unit 23 a characteristic performance graph is deposited, in which the adjusted specific speed values of the compressor 8 and the specific flow cross-section adjustments Q of the turbine 11 with regard to the efficiency improvement of the fuel cell 2 for the operating states of the heating phase and/or the idling operating phase and/or the load losses and/or the phase of the fuel cell, in which it requires no or only a small amount of oxidizing agent, are deposited.

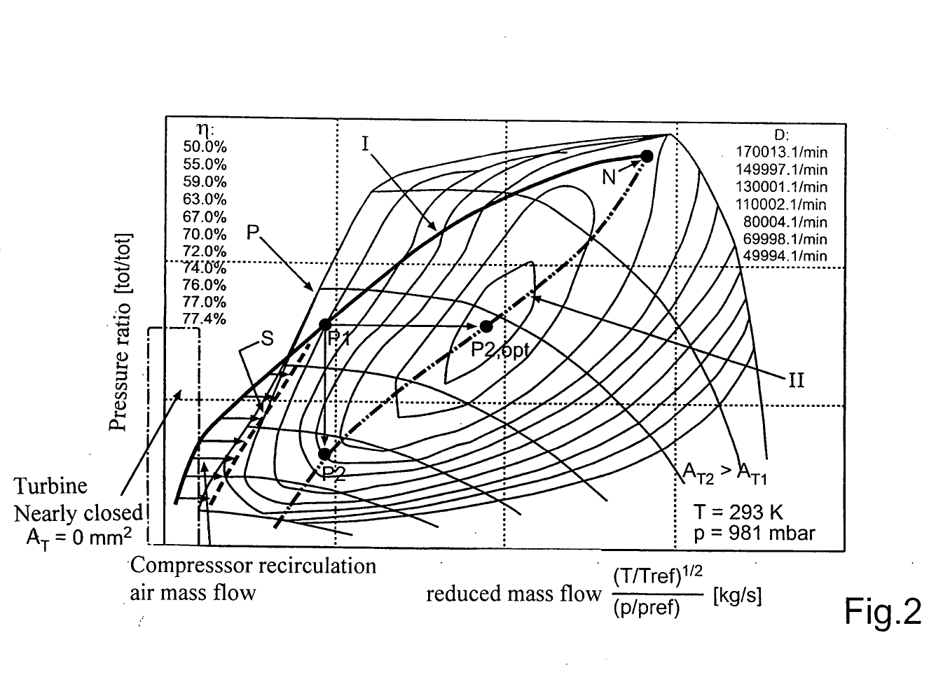

An exemplary compressor characteristic performance graph is shown in FIG. 2. The methods listed in the following can be executed in a reasonable manner with the shown air supply system, wherein the values can be retrieved from the operating lines entered into the compressor characteristic performance graph according to FIG. 2.

By the adjustment of the vane structure to the smallest flow cross-section Q of the turbine 11, which turbine may be for example an axial slider valve turbine or a pivotable vane turbine, with the adjusted compressor speed, operating lines of the compressor 8 can be generated, which are essentially in the optimum efficiency region of the turbine. The characteristic operating line of the fuel cell 2 can be influenced optimally by the air supply system in accordance with the device 6. The optimum pressures and temperatures in the fuel cell 2 are hereby provided with the desired air flow rate. For example, a nearly optimum course of an operating line of the fuel cell 2 in the characteristic zone of the compressor is generated by the turbine guidance in according with the course II with the smallest cross section A_{T2}. If the air mass flow rate and the compressor pressure ratio match the optimum fuel cell requirement, it can be assumed that the overall system operates at minimum fuel consumption as a result of an optimum charge change. It is herein a precondition that the variable turbine 11 is designed in an efficiency-optimized manner with regard to the mentioned performance graph.

From the requirement of the fuel cell 2, often air mass flow rate ratio pairings result, which correspond to the course I shown in FIG. 2. With this operating line course, the smallest cross-section of the fuel cell system 1, which is present in the variable turbine 11 in the adjustable opening of the of the guide vane structure 12, is noticeably reduced compared to the optimal line, so as to fulfill the pressure requirements with a given mass flow rate of the fuel cell 2. With a given nominal point N of the fuel cell 2, the operating line intersects the surge limit P in the lower flow rate region according to the course I and the ability of the stable pressure provision also has to be assigned in the unstable region of the compressor 8.

In this critical operating region, the recirculation valve 19 of the recirculation arrangement 17 is opened so far, that the compressor flow rate rises above the pump surge limit flow rate. The compressor absorption line is characterized by the line S in this region.

The fuel cell absorption line with the necessary pressure is beyond the stable compressor operating region, which does not disturb the ability to provide a stable pressure for the compressor 8.

A further operating mode, which can be in the compressor performance graph according to FIG. 2 to the right of the surge limit P, is the so-called bypass operation. A partial flow, which, in the above-mentioned case, was re-circulated to the inlet region of the compressor 8, is now conducted directly to the turbine 11 bypassing the fuel cell 2. This takes place via the bypass line 14 and the correspondingly open control valve 15. As the fuel cell 2 is bypassed in this phase, a relatively high pressure ratio between the compressor output 81 and the turbine 11 is present. The power requirements of the electric motor 9 are reduced by the energy conversion of the blow-by air flow into technical work utilized in the turbine 11. In certain operating phases, the bypass operation via the bypass line 14 is preferred to the more energy-intense recirculation operation on the compressor side via the recirculation line 17.

In the heating phase of the fuel cell 2 after its cold start, the lower efficiency in the region of the compressor 8 is used close to the surge limit in the region of the line S, so as to reach the necessary operating temperature of the fuel cell 2 as quickly as possible. The energy supply for the temperature increase by means of this recirculation operation via the recirculation arrangement 17 or the by-pass operation via the bypass line 14 occurs at the expense of a relative high energy consumption of the electric motor 9. In the idling operation of the fuel cell 2, the above-mentioned procedure is used during the heating phase of the fuel cell 2, wherein, in this regard, the blow-by via the bypass line 14 to the turbine 11 is considered to be the more energetically advantageous measure with regard to fuel consumption.

With a load loss are in phases in which the fuel cell 2 requires no, or only very small amounts of, oxidizing agent, the turbine may be completely or almost completely closed. If a certain operating pressure still has to be provided for the fuel cell 2, the compressor 8 can be operated in the unstable region for a certain time with moderate pump pressure fluctuations without risk of damage. By the timing of damping volumes upstream and downstream of the compressor 8, a relatively good behavior of the compressor 8 can be achieved in the unstable lower speed range. This is especially achieved by the cathode gas recirculating arrangement already mentioned above, with which the cathode gas can be returned from the outlet of the cathode chamber 3 back to the input of the cathode chamber. A corresponding operation is thereby possible with a small mass flow rate and necessary pressure. The oxidizing agent column in the fuel cell 2 or the fuel cell stack can also be caused to oscillate and oxidizing agent can be used, as is required by the fuel cell 2. As with the explanation above of the freely accessible operating lines in the compressor characteristic performance graph according to FIG. 2, by means of the control of the variable turbine 11 and the speed of the compressor 8 via the electric motor 9, this enormous advantage of this variable turbine 11 is again pointed out referring to the operating points P₁, P₂ and P_{2, OPT}.

Starting with the operating point P₁ as the “optimum point of the combustion” and the operating point P₂ as the “optimum point of the load change-over” (optimum compressor and turbine efficiency) with the same mass flow rate, and the operating point P_{2,OPT} as the “optimum point of the load change-over with the same pressure ratio”, the optimum overall efficiency of the fuel cell 2 can be determined experimentally together with the oxidizing agent supply for the viewed operating point via the variation of the speed of the compressor 8 and variation the cross section Q of the variable turbine 11. This can also be achieved by a simulation procedure.

The result of the combination of the speed of the compressor 8, and the position of the guide vane structure 12 in the turbine 11 with regard to the change of the flow cross section Q for the optimum pressure and the optimum flow rate of the oxidizing agent at, or respectively through, the fuel cell 2 is recorded electronically as a characteristic performance graph in the control unit 23, so as to ensure the optimum economical drive operation.

What is claimed is:

1. An arrangement for providing a fuel cell (2) with an oxidizing agent comprising a cathode chamber (3), a supply line (7) extending to the cathode chamber (3) of the fuel cell (2) for supplying an oxidizing agent thereto, a compressor (8) connected in the supply line (7), a discharge line (13) extending from the cathode chamber (3) to an expander (11), a bypass line (14) extending between an output (81) of the compressor (8) and an input of the discharge line (13) leading to the expander (11) and bypassing the fuel cell (2), a first flow control valve (15) arranged in the bypass line (14), and a recirculation arrangement (17) branching off from the supply line (7) downstream of the compressor (8) and extending to the supply line (7) upstream of the compressor (8) for re-circulating oxidizing agent to the compressor (8).

2. The arrangement according to claim 1, wherein the expander is a turbine (11) with a variable turbine guide vane structure (12).

3. The arrangement according to claim 1, wherein a second flow control valve (19) is arranged in the recirculation arrangement (17) for returning oxidizing agent, the second control valve(19) being adapted to be opened at least intermittently in a heating phase of the fuel cell (2) and during an idling operating phase of the fuel cell (2).

4. The arrangement according to claim 1, wherein the first flow control valve (15) arranged in the bypass line (14) is adapted to be opened at least intermittently in a heating phase of the fuel cell (2) and during an idling operating phase of the fuel cell (2).

5. The arrangement according to claim 2, wherein the guide vane structure (12) of the turbine (11) is closed during a load loss of the fuel cell (2) or in a phase in which the fuel cell (2) requires no oxidizing agent.

6. The arrangement according to claim 5, wherein the expander (11) is closed during a load loss of the fuel cell (2) or in a phase in which the fuel cell (2) requires no oxidizing agent.

7. The arrangement according to claim 6, wherein during operation of the compressor, the oxidizing agent volumes which are present upstream and downstream of the compressor (8) are adjustable so as to permit a controllable compressor pumping operation via a return arrangement for recycling the cathode gas discharged from the cathode chamber (3) back to the cathode chamber (3).

8. The arrangement according to claim 1, wherein for an efficient operation of the fuel cell (2), operating states of the fuel cell (2) defined by the parameters oxidizing agent pressure and oxidizing agent mass flow have assigned to them specific speed values of the compressor (8) and specific adjustments of inlet flow cross sections (Q) of the expander (11), and these values are defined in a characteristic performance graph which is deposited in a control unit (23).

9. The arrangement according to claim 1, wherein, for an efficient operation of the fuel cell (2), the specific speed values of the compressor (8) and the specific cross section adjustments of the inlet flow cross-section of the expander (11) adapted for the operating states of the heating phase and/or the idle operating phase and the load loss or the phase in which the fuel cell (2) requires no oxidizing agent, are defined in a characteristic performance graph which is deposited in a control unit (23).

10. A method for providing a fuel cell (2) with an oxidizing agent comprising a cathode chamber (3) line (7) which leads to the cathode chamber (3) of the fuel cell (2) a compressor (8) connected in the supply line (7), a discharge line (13) extending from the cathode chamber (3), to an expander (11) and with a bypass line (14) extending between an output (81) of the compressor (8) and an input of the discharge line (13) leading to the expander (11) and bypassing the fuel cell (2) and a first flow control valve (15) arranged in the bypass line (14), and a recirculation arrangement (17) branching off from the supply line (7) downstream of the compressor (8) in the flow direction of the oxidizing agent, and extending to the supply line (7) upstream of the compressor (8) for returning oxidizing agent to the compressor (8), at least intermittently in specific operating states of the fuel cell (2) at least one of the control valves (15) of the bypass line (14) for permitting the oxidation agent to bypass the fuel cell (2) and the control valve (19) of the recirculation arrangement (17) for returning the oxidizing agent, which branches away from the supply line (7) downstream of the compressor (8) to the supply line (7) upstream of the compressor (8) is opened.

11. The method according to claim 10, wherein at least one of the control valve (15) of the bypass line (14) and the control valve (19) of the recirculation line (17) for recirculating the oxidizing agent are opened in the heating phase of the fuel cell (2).

12. The method according to claim 10, wherein at least one of the control valve (15) of the bypass line (14) and the control valve (19) of the recirculation line (17) for returning the oxidizing agent are opened during idle operation of the fuel cell (2).

13. The method according to claim 10, wherein at least one of the control valve (15) of the bypass line (14) and the control valve (17) of the recirculation line (17) for returning the oxidizing agent are opened during a load loss of the fuel cell (2) or during a phase in which the fuel cell (2) requires no oxidizing agent.

14. The method according to claim 10, wherein, in specific operating states of the fuel cell (2), the speed of the compressor (8) and the inlet flow cross-sections (Q) of the expander (11) suitable for optimum operating efficiency of the fuel cell (2) are retrieved from a performance graph deposited in the control unit (23) for adjusting the operating point of the fuel cell (2).

15. The method according to claim 10, wherein, in an operating phase of the fuel cell with load loss of the fuel cell (2) or during a phase in which the fuel cell (2) requires no oxidizing agent, the cross-section (Q) of the expander (11) is closed.
